(19) United States
(12) Patent Application Publication
(10) Pub. No.: US 2010/0020016 A1
(43) Pub. Date: Jan. 28, 2010

(54) Computer Mouse

(76) Inventor: Michael J. Monahan, Wilson, NC (US)

Correspondence Address: HARSHAW RESEARCH, INC., 210 W. TECUMSEH STREET, OTTAWA, KS, 66067, US

(21) Appl. No.: 12/180,192

(22) Filed: Jul. 25, 2008

(51) Int. Cl. G06F 3/033

(52) U.S. Cl. 345/164; 345/163

(57) ABSTRACT

A computer mouse includes a handheld casing and a motion detector coupled to the casing to detect movement of the casing. The computer mouse also includes a processor housed in the casing, the processor being in data communication with the motion detector to receive output of the motion detector. The processor includes programming to generate binary output signals from the output of the motion detector while not directly incorporating at least some respective motion detector output corresponding to inadvertent movements of the casing. The amount of movement considered inadvertent is adjustable by a user.

### BACKGROUND OF THE INVENTION

This application relates generally to a computer peripheral device such as a computer mouse and, more particularly, to a computer mouse. More particularly, the present invention relates to a computer mouse that ignores jerky movements indicative of unintended movements but responds to smooth movements indicative of intended mouse movements.

Using a computer mouse effectively may be difficult for individuals with disabilities that may cause spastic, jittery, or other unintended movements of the hand. If the computer mouse is moved back and forth too quickly, the cursor/arrow on the computer screen will move erratically, frustrating the user.

Various devices have been proposed in the prior art for assisting disabled users with the use of a computer mouse, such as system software that increases the size of a screen cursor or arrow. This enables a user to more efficiently and effectively move a computer mouse to a desired screen location. Similarly, computer operating systems in use with a computer mouse has been proposed to adjust the overall sensitivity of a mouse. In other words, a user may adjust how much cursor movement should be affected by a corresponding movement of the mouse. Although assumably effective for their intended purposes, the existing proposals do not filter the jerky movements of a computer mouse indicative of unintended movements such that only intentional smooth movements of the mouse are implemented.

Therefore, it would be desirable to have a computer mouse that translates jerky movements into smooth movements of the cursor. Further, it would be desirable to have a computer mouse that filters unintended movements thereof without the need for any corresponding computer software. In other words, it is desirable that the computer mouse is a standalone device usable with any computer.

### SUMMARY OF THE INVENTION

Therefore, a computer mouse according to the present invention includes a handheld casing and a motion detector coupled to the casing to detect movement of the casing. The computer mouse also includes a processor housed in the casing, the processor being in data communication with the motion detector to receive output of the motion detector. The processor includes programming to generate binary output signals from the output of the motion detector while not directly incorporating at least some respective motion detector output corresponding to inadvertent movements of the casing. The amount of movement considered inadvertent is adjustable by a user.

Therefore, a general object of this invention is to provide a computer mouse that filters jerky movements of the mouse into smooth and steady movements.

Another object of this invention is to provide a computer mouse, as aforesaid, having a motion detector and a processor for filtering mouse movement without any corresponding software product running on a computer.

Still another object of this invention is to provide a computer mouse, as aforesaid, that measures movement in a first and second direction and determines if each such movement occurred within a predetermined timeframe indicative of an unintended mouse movement.

Yet another object of this invention is to provide a computer mouse, as aforesaid, that generates output signals if a time has expired, indicative of intentional mouse movements.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a flowchart illustrating the logic performed by a processor in relation to a computer mouse according to a preferred embodiment of the present invention;

FIG. 2 is a perspective view of a computer mouse according to a preferred embodiment of the present invention; and

FIG. 3 is an exploded view of a computer mouse casing as in FIG. 2.

### DESCRIPTION OF THE PREFERRED EMBODIMENT

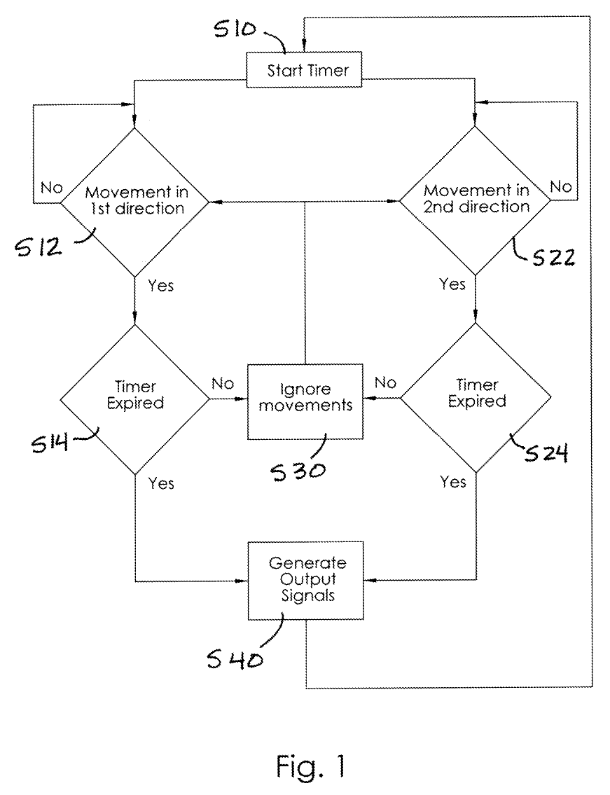

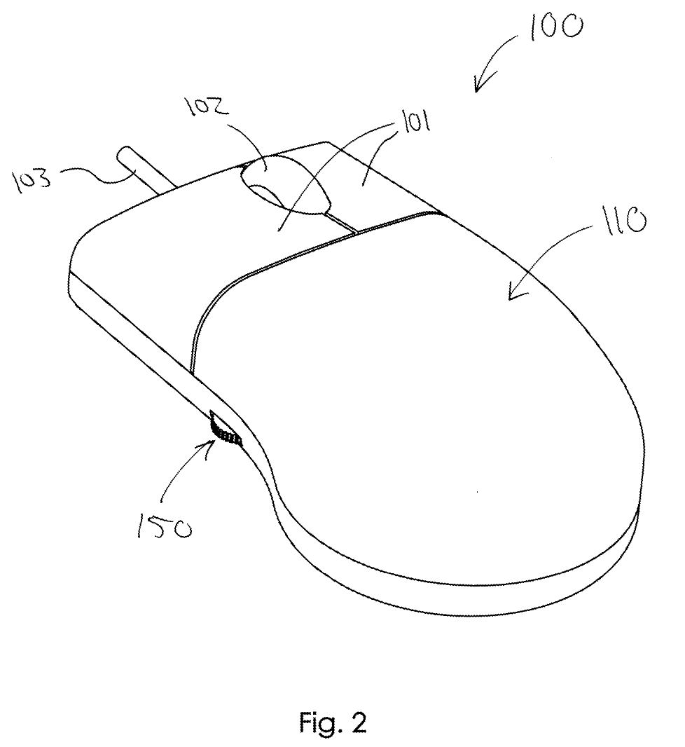

A computer mouse will now be described in detail with reference to FIG. 1 through FIG. 3 of the accompanying drawings. More particularly, a computer mouse 100 includes a handheld casing 110 (FIG. 2) and a motion detector 120 coupled to the casing 110 to detect movement of the casing 110. Though not discussed in detail below, the computer mouse 100 may include button(s) 101, a scroll wheel 102, and other traditional features in addition to the inventive features set forth herein.

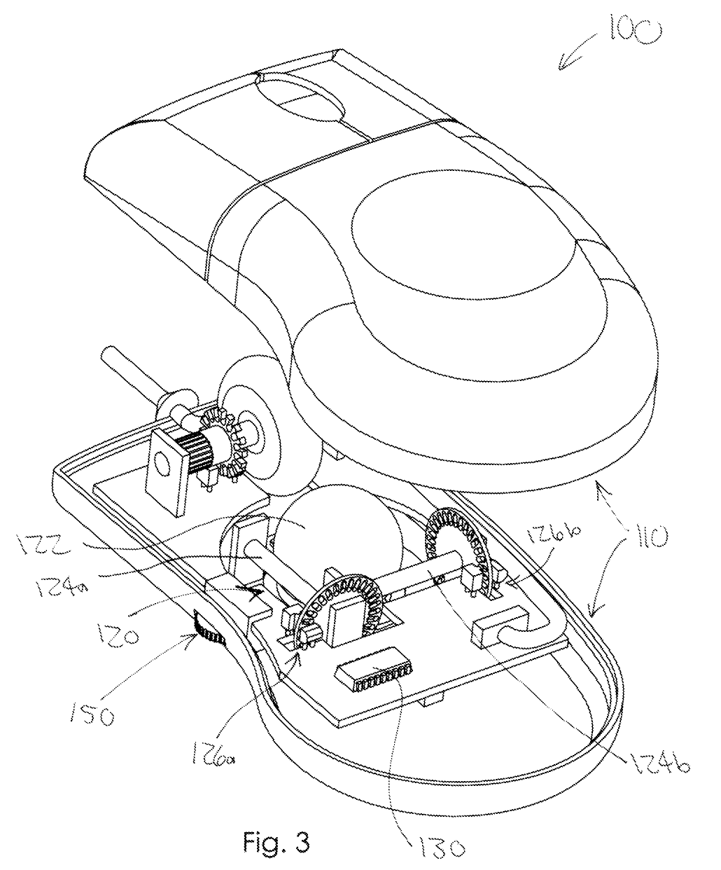

As shown in FIG. 3, the motion detector 120 may include a ball 122 in communication with first and second rollers 124a, 124b. A first encoder 126a may be in communication with the first roller 124a to indicate speed and distance in one direction (e.g., in a direction “x”), and a second encoder 126b may be in communication with the second roller 124b to indicate speed and distance in another direction (e.g., in a direction “y”). Alternately, any other appropriate motion detector 120 may be used, such as one that includes an optical motion detector that uses LED or laser light (for example) that bounces off an adjacent stationary surface back to a sensor without the ball 122, rollers 124a, 124b, and encoders 126a, 126b.

A processor 130 is in the casing 110 (FIG. 3), and the processor 130 is in data communication with the motion detector 120 to receive output of the motion detector 120. The processor 130 includes programming to generate smoothed binary output signals from the output of the motion detector 120. To generate smoothed binary output signals, the programming may not directly incorporate at least some output from the motion detector 120 that corresponds to inadvertent movements of the casing 110. For example, as shown in routine 140 in FIG. 1, the programming may use motion detector output obtained at a time interval to generate the smoothed binary output signals.

More particularly, routine 140 starts at step S10, where the programming starts a timer device. The routine 140 proceeds to steps S12, where the programming determines from the motion detector output if the casing 110 has moved in one direction (e.g., in a direction “x”); if so, the processor 130 determines at step S14 if a time interval that began at step S10 has expired. If the time interval has not expired, the processor 130 ignores the movements at step S30. If the time interval has expired, the processor 130 generates a binary output signal at step S40 that reflects the movement in the first direction at the end of the time interval. The routine 140 returns from step S40 to step S10.

The routine 140 also proceeds from step S10 to step S22, where the programming determines from the motion detector output if the casing 110 has moved in another direction (e.g., in a direction “y”); if so, the processor 130 determines at step S24 if the time interval that began at step S10 has expired. If the time interval has not expired, the processor 130 ignores the movements at step S30. If the time interval has expired, the processor 130 generates a binary output signal at step S40 that reflects the movement in the second direction at the end of the time interval. As noted above, the routine 140 returns from step S40 to step S10.

An input 150 (FIGS. 2 and 3) may be in data communication with the processor 130 to adjust the time interval used to generate the smoothed binary output signals (e.g., in the routine 140).

In another embodiment, the programming uses a filter instead of (or in addition to) a timer interval routine (e.g., routine 140) to translate motion detector output corresponding to inadvertent casing movements into smoothed data, and then use the smoothed data in generating the binary output signal. For example, high pass and low pass filters may be used to smooth motion detector output corresponding to inadvertent casing movements in generating smoothed binary output signals, or a Kalman filter may be used to smooth motion detector output corresponding to inadvertent casing movements in generating smoothed binary output signals. To determine an amount of inadvertent casing movement required for a corresponding motion detector output to be not directly incorporated into binary output signals, the input 150 (FIGS. 2 and 3) may be in data communication with the processor to adjust the filter(s).

In use, the computer mouse 100 is placed in data communication with a computer device, such as through cord 103, for example. The user may hold the casing 110 and move the casing 110 relative to a stationary surface (e.g., a desktop) in a traditional manner. The motion detector 120 detects the movement of the casing 110 and provides output signals to the processor 130 that indicate the movement of the casing 110, and the programming causes the processor 130 to generate smoothed binary output signals (as discussed above). The processor 130 may then provide the smoothed binary output signals to the computer (e.g., through cord 103). By generating smoothed binary output signals, the computer mouse 100 may allow users with unsteady hands to nevertheless easily and effectively operate a computer.

It is understood that while certain forms of this invention have been illustrated and described, it is not limited thereto except insofar as such limitations are included in the following claims and allowable functional equivalents thereof.

1. A computer mouse, comprising:
a handheld casing;
a motion detector coupled to said casing to detect movement of said casing;
a processor housed in said casing, said processor being in data communication with said motion detector to receive output of said motion detector; and
programming in said processor to generate smoothed binary output signals from said output of said motion detector.

2. The computer mouse of claim 1, wherein said programming in said processor uses a high pass filter and a low pass filter to smooth motion detector output corresponding to inadvertent casing movements in generating smoothed binary output signals.

3. The computer mouse of claim 2, further comprising an input in data communication with said processor to adjust said high pass filter and said low pass filter.

4. The computer mouse of claim 1, wherein said programming in said processor uses a Kalman filter to smooth motion detector output corresponding to inadvertent casing movements in generating smoothed binary output signals.

5. The computer mouse of claim 4, further comprising an input in data communication with said processor to adjust said Kalman filter.

6. The computer mouse of claim 1, wherein said programming in said processor uses respective motion detector output obtained at a time interval to generate said smoothed binary output signals.

7. The computer mouse of claim 6, wherein said motion detector includes:
a ball in communication with first and second rollers;
a first encoder in communication with said first roller to indicate speed and distance in one direction; and
a second encoder in communication with said second roller to indicate speed and distance in another direction.

8. The computer mouse of claim 7, further comprising an input in data communication with said processor to adjust said time interval.

9. The computer mouse of claim 6, further comprising an input in data communication with said processor to adjust said time interval.

10. The computer mouse of claim 1, wherein said motion detector includes:
a ball in communication with first and second rollers;
a first encoder in communication with said first roller to indicate speed and distance in one direction; and
a second encoder in communication with said second roller to indicate speed and distance in another direction.

11. A computer mouse, comprising:
a handheld casing;
a motion detector coupled to said casing to detect movement of said casing;
a processor housed in said casing, said processor being in data communication with said motion detector to receive output of said motion detector; and
programming in said processor to generate binary output signals from said output of said motion detector while not directly incorporating at least some respective motion detector output corresponding to inadvertent movements of said casing.

12. The computer mouse of claim 11, further comprising an input in data communication with said processor to determine an amount of inadvertent casing movement required for a corresponding motion detector output to be not directly incorporated into said binary output signals.

13. The computer mouse of claim 11, wherein said programming in said processor uses respective motion detector output obtained at a time interval to generate said binary output signals.

14. The computer mouse of claim 13, wherein said motion detector includes:
a ball in communication with first and second rollers;
a first encoder in communication with said first roller to indicate speed and distance in one direction; and
a second encoder in communication with said second roller to indicate speed and distance in another direction.

15. The computer mouse of claim 13, further comprising an input in data communication with said processor to adjust said time interval.

16. The computer mouse of claim 11, wherein:
said programming in said processor to generate binary output signals uses a high pass filter and a low pass filter to smooth motion detector output corresponding to inadvertent casing movements in generating binary output signals; and
an input is in data communication with said processor to adjust said high pass filter and said low pass filter.

17. The computer mouse of claim 11, wherein:
said programming in said processor to generate binary output signals uses a Kalman filter to smooth motion detector output corresponding to inadvertent casing movements in generating binary output signals; and
an input is in data communication with said processor to adjust said Kalman filter.

18. A computer mouse, comprising:
a handheld casing;
a motion detector coupled to said casing to detect movement of said casing;
a processor housed in said casing, said processor being in data communication with said motion detector;
programming in said processor to generate binary output signals from output of said motion detector while not directly incorporating respective motion detector output corresponding to inadvertent movements of said casing; and
wherein said programming in said processor to generate binary output signals translates said motion detector output corresponding to inadvertent casing movements into smoothed data and uses said smoothed data in generating said binary output signal.

19. The computer mouse of claim 18, further comprising an input in data communication with said processor to determine a level of inadvertency for not directly incorporating inadvertent movements of said casing in generating said binary output signals.

20. The computer mouse of claim 19, wherein:
said programming in said processor translating said motion detector output corresponding to inadvertent casing movements into smoothed data uses at least one filter; and
said input is in data communication with said processor to adjust said at least one filter.
